(19) United States
(12) Patent Application Publication
(10) Pub. No.: US 2020/0269831 A1
(43) Pub. Date: Aug. 27, 2020

(54) HYBRID VEHICLE DRIVE APPARATUS

(71) Applicant: Honda Motor Co., Ltd., Tokyo (JP)

(72) Inventor: Takahiro Kasahara, Wako-shi (JP)

(21) Appl. No.: 16/792,846

(22) Filed: Feb. 17, 2020

(30) Foreign Application Priority Data
Feb. 27, 2019 (JP) 2019-033581

(51) Int. Cl. B60W 20/10; B60K 6/26; B60K 6/24; F02N 11/04; F02N 15/02; B60K 1/02; B60K 17/22; B60K 6/365; B60K 6/54; B60K 6/383; B60W 10/06; B60W 10/08; B60W 10/115; B60W 10/02; F02N 11/08; F16H 3/44

(52) U.S. Cl. CPC B60W 20/10; B60W 2710/021; B60K 6/24; F02N 11/04; F02N 15/02; B60K 1/02; B60K 17/22; B60K 6/365; B60K 6/54; B60K 6/383; B60W 10/06; B60W 10/08; B60W 10/115; B60W 10/02; F02N 11/0803; F16H 3/44; B60Y 2200/92; B60K 2006/266; B60K 2006/268; B60W 2710/06; B60W 2710/08; B60W 2710/10; B60K 6/26

(57) ABSTRACT

A drive apparatus of a hybrid vehicle including an internal combustion engine, a first motor-generator, a second motor-generator, a planetary gear mechanism, a speed change mechanism and an electronic control unit. The speed change mechanism includes a first engagement mechanism and a second engagement mechanism. A microprocessor of the electronic control unit is configured to perform controlling the speed change mechanism so as to disengage the first engagement mechanism and engage the second engagement mechanism before a driving force increase instruction is output during traveling in an EV reverse mode and so as to engage the first engagement mechanism and disengage the second engagement mechanism when it is determined that the driving force increase instruction is output during traveling in the EV reverse mode.

### CROSS-REFERENCE TO RELATED APPLICATION

This application is based upon and claims the benefit of priority from Japanese Patent Application No. 2019-033581 filed on Feb. 27, 2019, the content of which is incorporated herein by reference.

### BACKGROUND OF THE INVENTION

### Field of the Invention

This invention relates to a drive apparatus of a hybrid vehicle.

### Description of the Related Art

Conventionally, there is a known apparatus of this type that includes an engine, a first electric motor (first motor-generator), a second electric motor (second motor-generator), a power splitting planetary gear mechanism able to split power generated by the engine between output side and first electric motor side, a speed ratio changing planetary gear mechanism for changing speed ratio of rotation output from the output side, and multiple frictional engagement mechanisms. Such an apparatus is described, for example, in Japanese Patent Publication No. 5391959 (JP5391959B). In the apparatus described in JP5391959B, a configuration is adopted that controls engaging action of the multiple frictional engagement mechanisms to enable implementation of an EV mode for traveling by power of the second electric motor with the engine stopped, a series mode for traveling by power of the second electric motor while the first electric motor is driven to generate electricity by power of the engine, and a HV mode for traveling by power of the engine and power of the second motor.

However, the apparatus to according JP5391959B has an issue regarding a reverse travel in EV mode in cases requiring large driving force such as when riding over a step or the like. This is because maximum driving force of the apparatus according to JP5391959B during the reverse travel in EV mode is dictated by capacity of the second electric motor, so that increasing driving force requires use of a larger second motor and therefore leads to increased cost and larger overall apparatus size.

### SUMMARY OF THE INVENTION

An aspect of the present invention is a drive apparatus of a hybrid vehicle including: an internal combustion engine; a first motor-generator; a drive shaft connected to a wheel; a power division mechanism connected to an output shaft of the internal combustion engine to divide and output a power generated by the internal combustion engine to the first motor-generator and a power transmission path configured to connect the power division mechanism and the drive shaft; a second motor-generator disposed in the power transmission path; a planetary gear mechanism interposed between the second motor-generator and the power division mechanism in the power transmission path; a speed change mechanism including a first engagement mechanism configured to be engageable and disengageable and a second engagement mechanism configured to be engageable and disengageable so as to change a speed ratio defined as a value of a ratio of a rotational speed of an input shaft of the planetary gear mechanism relative to a rotational speed of an output shaft of the planetary gear mechanism, in accordance with an engagement action of the first engagement mechanism and the second engagement mechanism; and an electronic control unit including a microprocessor configured to perform controlling the internal combustion engine, the first motor-generator, the second motor-generator and the speed change mechanism in accordance with a drive mode. The speed change mechanism is configured so that the speed ratio is a first speed ratio when the first engagement mechanism is disengaged and the second engagement mechanism is engaged and the speed ratio is a second speed ratio less than the first speed ratio when the first engagement mechanism is engaged and the second engagement mechanism is disengaged. The drive mode includes an EV reverse mode driven by a power of the second motor-generator with the internal combustion engine inactivated to travel in reverse. The microprocessor is configured to further perform determining whether a driving force increase instruction is output during traveling in the EV reverse mode, and the microprocessor is configured to perform the controlling including controlling the speed change mechanism so as to disengage the first engagement mechanism and engage the second engagement mechanism before the driving force increase instruction is output during traveling in the EV reverse mode and so as to engage the first engagement mechanism and disengage the second engagement mechanism when it is determined that the driving force increase instruction is output during traveling in the EV reverse mode.

### BRIEF DESCRIPTION OF THE DRAWINGS

The objects, features, and advantages of the present invention will become clearer from the following description of embodiments in relation to the attached drawings, in which:

FIG. 1 is a diagram showing schematically a configuration overview of a drive apparatus of a hybrid vehicle according to an embodiment of the invention;

FIG. 2 is a diagram showing an example of drive modes implemented by the drive apparatus of the hybrid vehicle according to the embodiment of the invention;

FIG. 3 is an alignment chart showing an example of operation in EV reverse mode in a drive apparatus of a hybrid vehicle as a comparative example of the present embodiment;

FIG. 4A is an alignment chart showing an example of operation in EV reverse mode in the drive apparatus of the hybrid vehicle according to the present embodiment;

FIG. 4B is an alignment chart showing an example of operation following FIG. 4A;

FIG. 5 is a flowchart showing an example of processing performed by a controller of FIG. 1;

FIG. 6 is a time chart showing an example of operation in the drive apparatus of the hybrid vehicle according to the present embodiment;

FIG. 7 is a time chart showing an example of modification of FIG. 6; and

FIG. 8 is a time chart showing an example of another modification of FIG. 6.

### DETAILED DESCRIPTION OF THE INVENTION

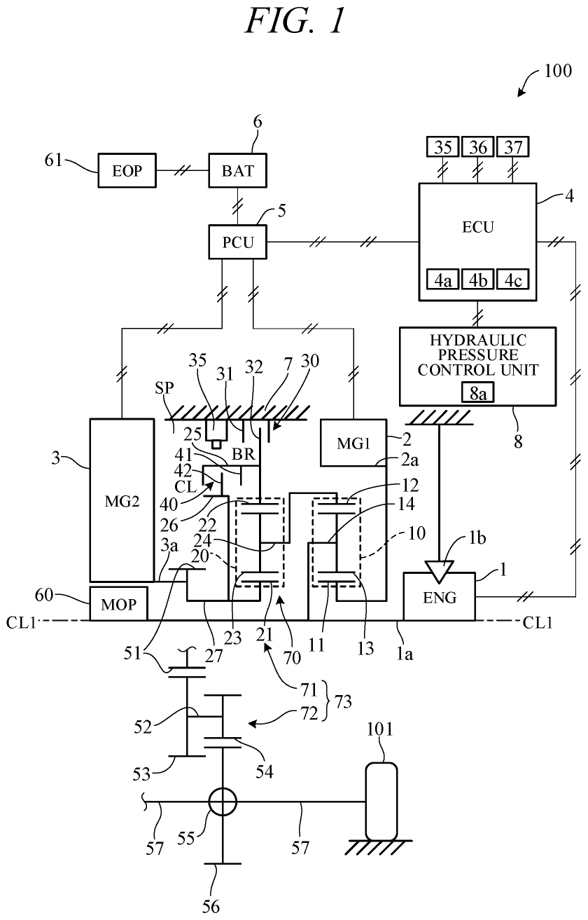

Hereinafter, an embodiment of the present invention is explained with reference to FIGS. 1 to 8. A drive apparatus according to an embodiment of the present invention is applied to a hybrid vehicle including an engine and a motor-generator as a drive power source. FIG. 1 is a diagram showing schematically a configuration overview of a drive apparatus 100 of a hybrid vehicle according to the present embodiment.

As shown in FIG. 1, the drive apparatus (vehicle drive apparatus) 100 includes an engine (ENG) 1, first and second motor-generators (MG1 and MG2) 2 and 3, a first planetary gear mechanism 10 for dividing motive power, and a second planetary gear mechanism 20 for changing speed ratio.

The engine 1 is an internal combustion engine (e.g., gasoline engine) wherein intake air supplied through a throttle valve and fuel injected from an injector are mixed at an appropriate ratio and thereafter ignited by a sparkplug or the like to burn explosively and thereby generate rotational power. A diesel engine or any of various other types of engine can be used instead of a gasoline engine. Throttle valve opening, quantity of fuel injected from the injector (injection time and injection time period) and ignition time are, inter alia, controlled by a controller (ECU) 4.

An output shaft 1a of the engine 1 extends centered on axis (axial line) CL1. The engine 1 incorporates a one-way clutch 1b which allows rotation (normal rotation) of the output shaft 1a in positive direction and prevents rotation (reverse rotation) of the output shaft 1a in negative direction. The engine 1 can generate driving force for forward travel of the vehicle.

The first and second motor-generators 2 and 3 each has a substantially cylindrical rotor centered on axis CL1 and a substantially cylindrical stator installed around the rotor and can function as a motor and as a generator. Namely, the rotors of the first and second motor-generators 2 and 3 are driven by electric power supplied from a battery 6 through a power control unit (PCU) 5 to coils of the stators. In such case, the first and second motor-generators 2 and 3 function as motors.

On the other hand, when rotating shafts 2a and 3a of rotors of the first and second motor-generators 2 and 3 are driven by external forces, the first and second motor-generators 2 and 3 generate electric power that is applied through the power control unit 5 to charge the battery 6. In such case, the first and second motor-generators 2 and 3 function as generators. During normal vehicle traveling, such as during cruising or acceleration, for example, the first motor-generator 2 functions chiefly as a generator and the second motor-generator 3 functions chiefly as a motor.

The power control unit 5 incorporates an inverter controlled by instructions from the controller 4 so as to individually control output torque or regenerative torque of the first motor-generator 2 and the second motor-generator 3. The first and second motor-generators 2 and 3 can rotate in positive direction and negative direction.

The first motor-generator 2 and the second motor-generator 3 are coaxially installed at spaced locations. The first motor-generator 2 and second motor-generator 3 are, for example, housed in a common case 7, and a space SP between them is enclosed by the case 7. Optionally, the first motor-generator 2 and second motor-generator 3 can be housed in separate cases.

The first planetary gear mechanism 10 and second planetary gear mechanism 20 of single pinion type are installed in the space SP between the first motor-generator 2 and second motor-generator 3. Specifically, the first planetary gear mechanism 10 is situated on the side of the first motor-generator 2 and the second planetary gear mechanism 20 on the side of the second motor-generator 3.

The first planetary gear mechanism 10 includes a first sun gear 11 and a first ring gear 12 installed around the first sun gear 11, both of which rotate around axis CL1, multiple circumferentially spaced first pinions (planetary gears) 13 installed between the first sun gear 11 and first ring gear 12 to mesh with these gears 11 and 12, and a first carrier 14 that supports the first pinions 13 to be individually rotatable around their own axes and collectively revolvable around axis CL1.

Similarly to the first planetary gear mechanism 10, the second planetary gear mechanism 20 includes a second sun gear 21 and a second ring gear 22 installed around the second sun gear 21, both of which rotate around axis CL1, multiple circumferentially spaced second pinions (planetary gears) 23 installed between the second sun gear 21 and second ring gear 22 to mesh with these gears 21 and 22, and a second carrier 24 that supports the second pinions 23 to be individually rotatable around their own axes and collectively revolvable around axis CL1.

The output shaft 1a of the engine 1 is connected to the first carrier 14, and power of the engine 1 is input to the first planetary gear mechanism 10 through the first carrier 14. On the other hand, when the engine 1 is started, power from the first motor-generator 2 is input to the engine 1 through the first planetary gear mechanism 10. The first sun gear 11 is connected to the rotating shaft 2a of the rotor of the first motor-generator 2, and the first sun gear 11 and first motor-generator 2 (rotor) rotate integrally. The first ring gear 12 is connected to the second carrier 24, and the first ring gear 12 and second carrier 24 rotate integrally.

Owing to this configuration, the first planetary gear mechanism 10 can output power received from the first carrier 14 through the first sun gear 11 to the first motor-generator 2 and output power through the first ring gear 12 to the second carrier 24 on an axle (drive shaft) 57 side. In other words, it can dividedly output power from the engine 1 to the first motor-generator 2 and the second planetary gear mechanism 20.

An axis CL1-centered substantially cylindrical outer drum 25 is provided radially outside the second ring gear 22. The second ring gear 22 is connected to and rotates integrally with the outer drum 25. A brake mechanism 30 is provided radially outward of the outer drum 25. The brake mechanism 30 is, for example, structured as a multi-plate wet brake including multiple radially extending plates (friction members) 31 arranged in axial direction and multiple radially extending disks (friction members) 32 arranged in axial direction (multiple illustration is omitted in the drawing). The plates 31 and disks 32 are alternately arranged in axial direction. In other words, the brake mechanism 30 includes plates 31 and disks 32 as a plurality of friction engagement elements.

The multiple plates 31 are circumferentially non-rotatably and axially movably engaged at their radial outer ends with the inner peripheral surface of the surrounding wall of the case 7. The multiple disks 32 rotate integrally with the outer drum 25 owing to their radially inner ends being engaged with outer peripheral surface of the outer drum 25 to be circumferentially non-rotatable and axially movable relative to the outer drum 25. A non-contact rotational speed sensor 35 for detecting rotational speed of the outer drum 25 is provided on inner peripheral surface of the case 7 to face outer peripheral surface of the outer drum 25 axially sideward of the brake mechanism 30.

The brake mechanism 30 includes a spring (not shown) for applying biasing force acting to separate the plates 31 and disks 32 and thus release the disks 32 from the plates 31, and a piston (not shown) for applying pushing force acting against the biasing force of the spring to engage the plates 31 and disks 32. The piston is driven by hydraulic pressure supplied through a hydraulic pressure control unit 8.

In a state with no hydraulic pressure acting on the piston, the plates 31 and disks 32 separate, thereby releasing (turning OFF) the brake mechanism 30 and allowing rotation of the second ring gear 22. On the other hand, when hydraulic pressure acts on the piston, the plates 31 and disks 32 engage, thereby operating (turning ON) the brake mechanism 30. In this state, rotation of the second ring gear 22 is prevented. The configuration of the brake mechanism 30 is not limited to the above configuration. For example, the brake mechanism may be configured to generate braking force by pressing a friction member supported by the case 7 to an outer peripheral surface of the outer drum 25.

An axis CL1-centered substantially cylindrical inner drum 26 is provided radially inward of and facing the outer drum 25. The second sun gear 21 is connected to an output shaft 27 of a second planetary gear mechanism 20 that extends along axis CL1 and is connected to the inner drum 26, whereby the second sun gear 21, output shaft 27 and inner drum 26 rotate integrally. A clutch mechanism 40 is provided between the outer drum 25 and the inner drum 26.

The clutch mechanism 40 is, for example, structured as a multi-plate wet clutch including multiple radially extending plates (friction members) 41 arranged in axial direction and multiple radially extending disks (friction members) 42 arranged in axial direction (multiple illustration is omitted in the drawing). The plates 41 and disks 42 are alternately arranged in axial direction. In other words, the clutch mechanism 40 includes plates 41 and disks 42 as a plurality of friction engagement elements.

The multiple plates 41 rotate integrally with the outer drum 25 owing to their radial outer ends being engaged with the inner peripheral surface of the outer drum 25 to be circumferentially non-rotatable and axially movable relative to the outer drum 25. The multiple disks 42 rotate integrally with the inner drum 26 owing to their radially inner ends being engaged with outer peripheral surface of the inner drum 26 to be circumferentially non-rotatable and axially movable relative to the inner drum 26.

The clutch mechanism 40 includes a spring (not shown) for applying biasing force acting to separate the plates 41 and disks 42 and thus release the disks 42 from the plates 41, and a piston (not shown) for applying pushing force acting against the biasing force of the spring to engage the plates 41 and disks 42. The piston is driven by hydraulic pressure supplied through the hydraulic pressure control unit 8.

In a state with no hydraulic pressure acting on the piston, the plates 41 and disks 42 separate, thereby releasing (turning OFF) the clutch mechanism 40 and allowing relative rotation of the second sun gear 21 with respect to the second ring gear 22. When rotation of the second ring gear 22 is prevented by the brake mechanism 30 being ON at this time, rotation of the output shaft 27 with respect to the second carrier 24 is accelerated. This state corresponds to speed ratio stage being shifted to high.

On the other hand, when hydraulic pressure acts on the piston, the plates 41 and disks 42 engage, thereby operating (turning ON) the clutch mechanism 40 and integrally joining the second sun gear 21 and second ring gear 22. When rotation of the second ring gear 22 is allowed by the brake mechanism 30 being OFF at this time, the output shaft 27 becomes integral with the second carrier 24 and rotates at the same speed as the second carrier 24. This state corresponds to speed ratio stage being shifted to low.

The second planetary gear mechanism 20, brake mechanism 30 and clutch mechanism 40 configure a speed change mechanism 70 that shifts rotation of the second carrier 24 between two speed stages (high and low) and outputs the shifted rotation from the output shaft 27. A value of ratio of a rotational speed of an input shaft (second carrier 24) relative to a rotational speed of the output shaft 27 (second sun gear 21) of the second planetary gear mechanism 20 is defined as speed ratio. The speed ratio α1 (called first speed ratio) in low-speed range is greater than the speed ratio α2 (called second speed ratio) in high-speed range. Torque transmission path from the first planetary gear mechanism 10 to the rotating shaft 3a of the rotor of the second motor-generator 3 through the speed change mechanism 70 configures a first power transmission path 71 in a power transmission path 73 from the first planetary gear mechanism 10 to the axles 57.

The output shaft 27 is connected to an output gear 51 centered on axis CL1. The rotating shaft 3a of the rotor of the second motor-generator 3 is connected to the output gear 51 so that the second motor-generator 3 (rotating shaft 3a) and the output gear 51 integrally rotate. A large-diameter gear 53 rotatable around a counter shaft 52 lying parallel to axis CL1 meshes with the output gear 51, and torque is transmitted to the counter shaft 52 through the large-diameter gear 53. Torque transmitted to the counter shaft 52 is transmitted through a small-diameter gear 54 to a ring gear 56 of a differential unit 55 and further transmitted through the differential unit 55 to the left and right axles (drive shaft) 57. Since this drives the wheels (for example, front wheels) 101, the vehicle travels. The rotating shaft 3a, output gear 51, large-diameter gear 53, small-diameter gear 54 and differential unit 55, inter alia, configure a second power transmission path 72 from the second motor-generator 3 to the axles 57 in the power transmission path 73.

An oil pump (MOP) 60 is installed radially inward of the rotor of the second motor-generator 3. The oil pump 60 is connected to the output shaft 1a of the engine 1 and driven by the engine 1. Oil supply necessary when the engine 1 is stopped is covered by driving an electric oil pump (EOP) 61 with power from the battery 6.

The hydraulic pressure control unit 8 includes electromagnetic valve, proportional electromagnetic valve, and other control valves (control valve 8a) actuated in accordance with electric signals. The control valve 8a operates to control hydraulic pressure flow to the brake mechanism 30, clutch mechanism 40 and the like in accordance with instructions from the controller 4. More specifically, the control valve 8a controls hydraulic oil flow to an oil chamber facing piston of the brake mechanism 30 and to an oil chamber facing piston of the clutch mechanism 40. This enables ON-OFF switching of the brake mechanism 30 and clutch mechanism 40. Hydraulic oil flow to the other portion is controlled by other control valve.

The controller (ECU) 4 as an electronic control unit incorporates an arithmetic processing unit having a CPU, ROM, RAM and other peripheral circuits, and the CPU includes an engine control ECU 4a, a speed change mechanism control ECU 4b and a motor-generator control ECU 4c. Alternatively, the multiple ECUs 4a to 4c need not be incorporated in the single controller 4 but can instead be provided as multiple discrete controllers 4 corresponding to the ECUs 4a to 4c.

The controller 4 receives as input signals from, inter alia, the rotational speed sensor 35 for detecting rotational speed of the drum 25, a vehicle speed sensor 36 for detecting vehicle speed, and an accelerator opening angle sensor 37 for detecting accelerator opening angle indicative of amount of accelerator pedal depression. Although not indicated in the drawings, the controller 4 also receives signals from a sensor for detecting rotational speed of the engine 1, a sensor for detecting rotational speed of the first motor-generator 2 and a sensor for detecting rotational speed of the second motor-generator 3.

Based on these input signals, the controller 4 decides drive mode in accordance with a predefined driving force map representing vehicle driving force characteristics defined in terms of factors such as vehicle speed and accelerator opening angle. In order to enable the vehicle to travel in the decided drive mode, the controller 4 controls operation of the engine 1, first and second motor-generators 2 and 3, the brake mechanism 30 and the clutch mechanism 40 by outputting control signals to, inter alia, an actuator for regulating throttle valve opening, an injector for injecting fuel, the power control unit 5 and the hydraulic pressure control unit 8 (control valve 8a).

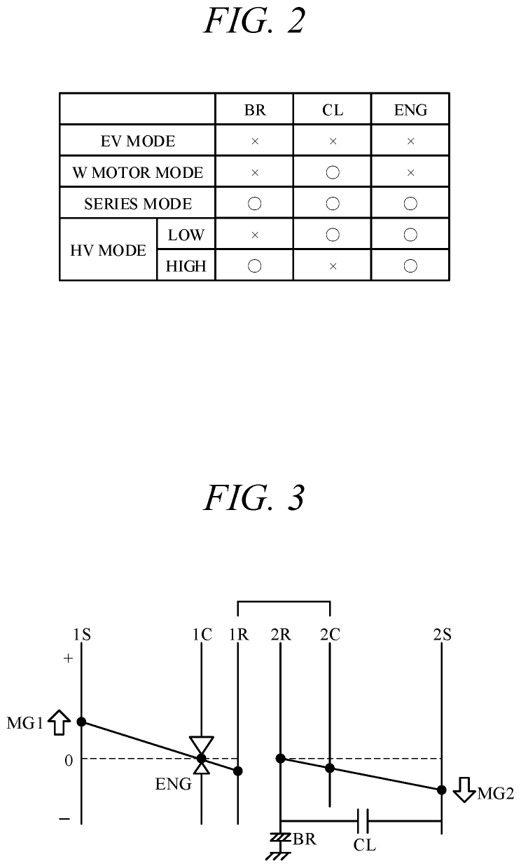

FIG. 2 is a table showing examples of some drive modes that can be implemented by the drive apparatus 100 according to the embodiment of the present invention, along with operating states of the brake mechanism (BR) 30, clutch mechanism (CL) 40 and engine (ENG) 1 corresponding to the different modes.

In FIG. 2, EV mode, W motor mode (double motor mode), series mode and HV mode are shown as typical drive modes in forward travel of the vehicle. HV mode is subdivided into low mode (HV low mode) and high mode (HV high mode). In the drawing, brake mechanism 30 ON (Engaged), clutch mechanism 40 ON (Engaged), and engine 1 Operating are indicated by symbol “o”, while brake mechanism 30 OFF (Disengaged), clutch mechanism 40 OFF (Disengaged), and engine 1 Stopped are indicated by symbol “x”.

In EV mode, the vehicle is driven for traveling solely by motive power of the second motor-generator 3. In EV mode, the vehicle travels forward when the second motor-generator 3 is rotated along the plus direction, while the vehicle travels backward when the second motor-generator 3 is rotated along the negative direction. In EV mode, the brake mechanism 30 and clutch mechanism 40 are both OFF, and the engine 1 is stopped, in accordance with instructions from the controller 4.

In W motor mode, the vehicle is driven for traveling by motive power of the first motor-generator 2 and the second motor-generator 3. In W motor mode, the brake mechanism 30 is OFF, the clutch mechanism 40 is ON and the engine 1 is stopped, in accordance with instructions from the controller 4.

In series mode, the vehicle is driven for traveling by motive power of the second motor-generator 3 while the first motor-generator 2 is being driven by motive power from the engine 1 to generate electric power. In series mode, the brake mechanism 30 and clutch mechanism 40 are both ON and the engine 1 is operated, in accordance with instructions from the controller 4.

In HV mode, the vehicle is driven for traveling by motive power produced by the engine 1 and the second motor-generator 3. Within the HV mode, the HV low mode corresponds to a mode of wide-open acceleration from low speed, and the HV high mode corresponds to a mode of normal traveling after EV traveling. In HV low mode, the brake mechanism 30 is OFF, the clutch mechanism 40 is ON and the engine 1 is operated, in accordance with instructions from the controller 4. In HV high mode, the brake mechanism 30 is ON, the clutch mechanism 40 is OFF and the engine 1 is operated, in accordance with instructions from the controller 4.

In the so-configured drive apparatus 100, reverse travel is performed in EV mode (called “EV reverse mode”). Specifically, when reverse travel is instructed by operation of a shift lever, the engine 1 is stopped by an instruction from the controller 4 and the vehicle is propelled by driving force from the second motor-generator 3. If one or more of wheels 101 should then hit a step-like rise during reverse travel, considerable driving force will be needed to ride over the rise. If this driving force is to be covered solely by the second motor-generator 3, a large second motor-generator 3 capable of producing high maximum torque must be adopted. This leads to high equipment cost and large size of the drive apparatus 100.

Two methods are conceivable for increasing driving force in EV reverse mode without increasing maximum torque of the second motor-generator 3. The first method is to mechanically prevent normal rotation of the engine 1 and once this condition is established to add torque of the first motor-generator 2 to the second motor-generator 3.

FIG. 3 is a diagram showing an example of an alignment chart in EV reverse mode according to the first method. In this diagram, first sun gear 11, first carrier 14 and first ring gear 12 are respectively designated 1S, 1C and 1R, and second sun gear 21, second carrier 24 and second ring gear 22 are respectively designated 2S, 2C and 2R. Rotational direction of the second sun gear 21 (second motor-generator 3) when the vehicle travels forward and rearward are respectively defined as positive direction and negative direction, and torque acting in positive direction is indicated by an upwardly pointing arrow and torque acting in negative direction by a downwardly pointing arrow.

In the first method, the one-way clutch 1b for preventing reverse rotation (negative direction rotation) of the output shaft 1a of the engine 1 is replaced by a two-way clutch. The two-way clutch is adapted to be switchable by an electromagnetic actuator between locked state and unlocked state. The electromagnetic actuator switches the two-way clutch to unlocked state during normal traveling when no increase in driving force is necessary. In unlocked state, normal rotation of the engine 1 is allowed and reverse rotation of the engine 1 is prevented. On the other hand, when a need to increase driving force arises during traveling in EV reverse mode, the electromagnetic actuator switches the two-way clutch to locked state in response to instruction from the controller 4. In locked state, both normal rotation and reverse rotation of the engine 1 are prevented.

At this time, as indicated in FIG. 3, when driving torque is added to the first motor-generator 2 with the brake mechanism 30 engaged, the first ring gear 12 and second carrier 24 both rotate in negative direction, thereby adding torque from the first motor-generator 2 to the second motor-generator 3. Driving force in EV reverse mode therefore increases. In the first method, however, the increase in number of components owing to the need for the two-way clutch increases cost and weight of the apparatus as a whole.

Although not illustrated, the second method requires a planetary gear mechanism or other torque amplification mechanism to be added in the second power transmission path 72. Increase in number of components therefore also increases cost and weight of the apparatus as a whole in the second method. Against this backdrop, the drive apparatus 100 according to the present embodiment is therefore configured as set out in the following in order to enable driving force increase in EV reverse mode while minimizing increase in number of components.

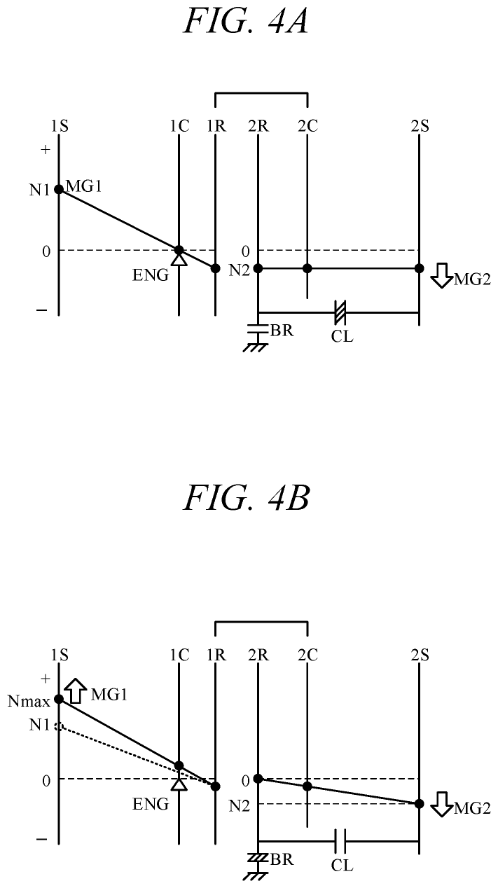

FIGS. 4A and 4B are diagrams showing examples of alignment charts in EV reverse travel controlled by the hybrid vehicle drive apparatus 100 in accordance with the present embodiment. Specifically, FIG. 4A is an example of an alignment chart showing operation before output of a reverse driving force increase instruction, and FIG. 4B is an example of an alignment chart showing operation after output of a reverse driving force increase instruction.

A reverse driving force increase instruction is output by the controller 4. For example, during EV reverse traveling, when vehicle speed detected by the vehicle speed sensor 36 is equal to or lower than a predetermined value and accelerator opening angle detected by the accelerator opening angle sensor 37 is equal to or greater than a predetermined value, the controller 4 determines that temporary increase of reverse driving force is necessary and outputs a reverse driving force increase instruction. As an actual situation in which a reverse driving force increase instruction is output can be cited a case such as when, during rear wheel traveling, collision of a wheel or wheels with a step (e.g., a curb) decreases vehicle speed and the driver increases accelerator pedal depression in order to ride over the step.

As shown in FIG. 4A, before output of a reverse driving force increase instruction during EV reverse traveling, the brake mechanism 30 is released and the clutch mechanism 40 is engaged in response to instructions from the controller 4. In addition, the second motor-generator 3 is rotationally driven in negative direction to generate driving force for vehicle reverse traveling. At this time, the second sun gear 21, second ring gear 22, second carrier 24 and first ring gear 12 rotate in negative direction at same rotational speed N2 as the second motor-generator 3. On the other hand, since negative direction rotation of the engine 1 is prevented by the one-way clutch 1b, the first carrier 14 (engine 1) does not rotate, and the first sun gear 11 and first motor-generator 2 rotate in normal direction at rotational speed N1. At this time, the first motor-generator 2 is fed only minimal current needed to sustain rotation, and torque of the first motor-generator 2 is substantially 0.

As shown in FIG. 4B, when a reverse driving force increase instruction is output thereafter, the brake mechanism 30 is engaged and the clutch mechanism 40 released in response to instructions from the controller 4, thereby performing an upshift from low-speed range to high-speed range. Namely, so-called clutch-to-clutch control is applied to switch engagement actions of the brake mechanism 30 and clutch mechanism 40 utilizing torque phase and inertia phase, whereby rotation of the second ring gear 22 stops. Inertia phase in switching transition state from low-speed range to high-speed range (during speed ratio transition) can generally be achieved by generating high torque in the output shaft 27. Driving force of the second motor-generator 3 can therefore be temporarily increased during switching transition from low-speed range to high-speed range.

In addition, the first motor-generator 2 is rotationally driven in positive direction in response to a command from the controller 4 synchronous with start of inertia phase, whereby rotational speed of the first motor-generator 2 rises to predetermined upper limit rotational speed Nmax and rotational speed of the first carrier 14 (engine 1) also concomitantly rises, as indicated in FIG. 4B, from the dotted line to the solid line. This torque from the first motor-generator 2 is added to the second motor-generator 3 through the first ring gear 12, second carrier 24 and second sun gear 21. Driving force of the second motor-generator 3 is boosted accordingly.

It is during switching transition from low-speed range to high-speed range that the first motor-generator 2 is rotationally driven in positive direction. Therefore, when rotational speed of the outer drum 25 detected by the rotational speed sensor 35 reaches a predetermined rotational speed following upshift, or when rotational speed of the first motor-generator 2 reaches upper limit rotational speed Nmax, torque of the first motor-generator 2 is returned to substantially 0.

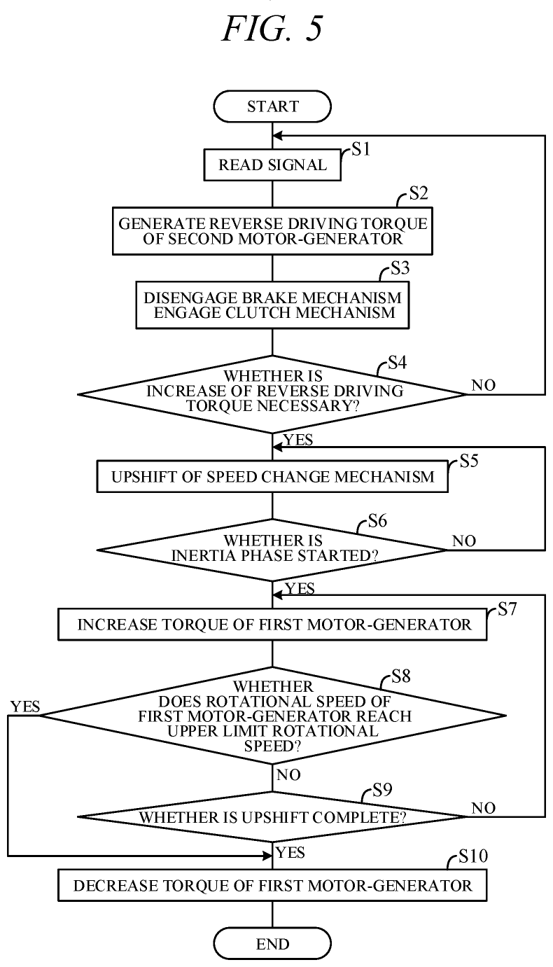

FIG. 5 is a flowchart showing an example of processing by the CPU of the controller 4 (mainly speed change mechanism control ECU 4b and motor-generator control ECU 4c), particularly an example of driving force increase processing during reverse traveling, performed in accordance with a program stored in memory in advance. The processing indicated in this flowchart is started, for example, when reverse traveling is instructed by driver operation of the shift lever.

First, in S1 (S: processing Step) of the flowchart in FIG. 5, signals are read from the sensors 35 to 37. Next, in S2, a control signal is output to the power control unit 5 to cause the second motor-generator 3 to generate reverse direction driving torque and to cause the second motor-generator 3 to rotate in negative direction at a rotational speed in accordance with amount of accelerator pedal depression detected by the accelerator opening angle sensor 37. Further, in S3, a control signal is output to the control valve 8a to disengage the brake mechanism 30 and engage the clutch mechanism 40, thereby controlling the speed change mechanism 70 to low-speed range. At this time, the engine 1 stops working and, as shown in FIG. 4A, engine speed is made 0 by action of the one-way clutch 1b. Further, the first motor-generator 2 rotates in positive direction concomitantly with negative direction rotation of the first ring gear 12. At this time, the controller 4 outputs a control signal to the power control unit 5 to control torque of the first motor-generator 2 to substantially 0 while maintaining minimal rotation of the first motor-generator 2.

Next, in S4, whether temporary increase of reverse driving force is necessary is determined based on signals from the vehicle speed sensor 36 and the accelerator opening angle sensor 37. This determination is performed, for example, by storing in memory in advance a reverse driving force increase required region mapped with respect to vehicle speed and accelerator opening angle and using signals from the vehicle speed sensor 36 and accelerator opening angle sensor 37 to determine whether operating point on the map falls in the reverse driving force increase required region. For example, the map can be created such that operating point is in the reverse driving force increase required region when vehicle speed is 0 and accelerator opening angle is a predetermined value or greater. Alternatively, whether temporary increase of reverse driving force is necessary can be determined simply by determining whether vehicle speed is equal to or lower than predetermined value and accelerator opening angle is equal to or greater than predetermined value. When the result in S4 is YES, the program goes to S5, and when NO, returns to S1.

In S5, upshift of the speed change mechanism 70 is started. Namely, clutch regripping is performed by outputting control signals to the control valve 8a to gradually lower engaging force (clutch torque) of the clutch mechanism 40 and gradually increase engaging force (clutch torque) of the brake mechanism 30 at a programmed time point. Next, in S6, signals from the rotational speed sensor 35 are used to determine whether predetermined rotational fluctuation of the second ring gear 22 is detected, i.e., whether inertia phase is started. When the result in S6 is YES, the program goes to S7, and when NO, returns to S5.

In S7, a control signal is output to the power control unit 5 to increase torque of the first motor-generator 2 to a predetermined value. This adds torque of the first motor-generator 2 to the second motor-generator 3. Moreover, rotational speed of the first motor-generator 2 increases concomitantly with increase in torque of the first motor-generator 2. Next, in S8, whether rotational speed of the first motor-generator 2 reaches upper limit rotational speed Nmax is determined based on a signal from a sensor that detects rotational speed of the first motor-generator 2. Upper limit rotational speed Nmax is set to a value not exceeding design-allowable rotational speed of the second motor-generator 3. When the result in S8 is NO, the program goes to S9, and when YES, skips S9 and goes to S10.

In S9, whether upshift is complete is determined based on a signal from the rotational speed sensor 35. Completion of upshift is determined, for example, from whether rotational speed of the second ring gear 22 became 0. When the result in S9 is YES, the program goes to S10, and when NO, returns to S7. In S10, a control signal is output to the power control unit 5 to lower driving torque of the first motor-generator 2 to a value barely capable of maintaining rotation, i.e., to almost 0, whereafter processing is terminated.

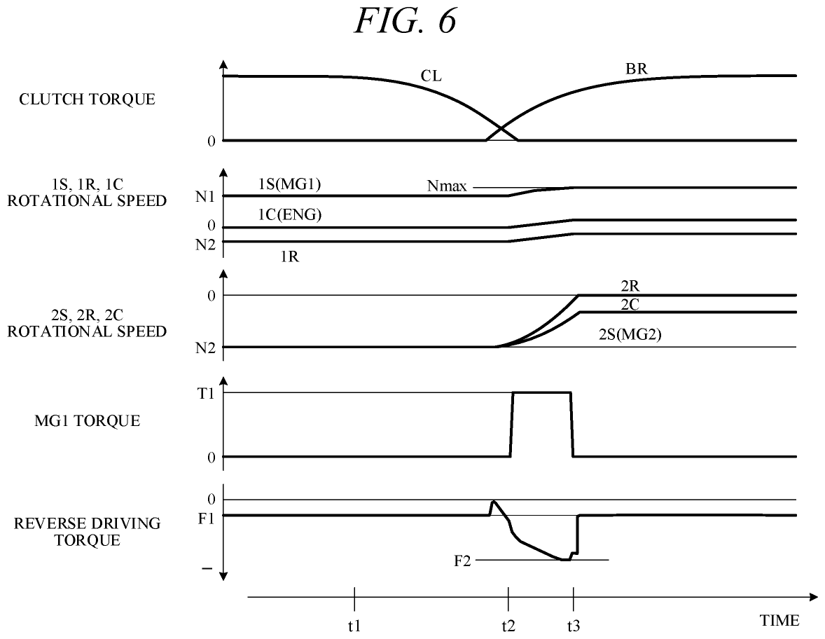

FIG. 6 is a time chart showing an example of operation of the hybrid vehicle drive apparatus 100 according to the present embodiment. FIG. 6 shows time-course change of clutch torques of the brake mechanism 30 (BR) and the clutch mechanism 40 (CL), rotational speeds of the first sun gear 11 (1S), first ring gear 12 (1R) and first carrier 14 (1C) of the first planetary gear mechanism 10, rotational speeds of the second sun gear 21 (2S), second ring gear 22 (2R) and second carrier 24 (2C) of the second planetary gear mechanism 20, torque of the first motor-generator 2 (MG1 torque), and reverse driving force.

As shown in FIG. 6, in initial state before time t1, clutch torque of the clutch mechanism 40 is maximum and clutch torque of the brake mechanism 30 is minimum (=0), and the speed change mechanism 70 is switched to low-speed range (S3). In this state, the second motor-generator 3 is rotationally driven at rotational speed N2 in negative direction to generate reverse driving force F1 (S2). At this time, rotational speed of the first carrier 14, i.e., engine speed, is 0, and the first ring gear 12, second sun gear 21, second ring gear 22 and second carrier 24 all rotate in negative direction at same speed (=N2). Further, torque of the first motor-generator 2 is substantially 0, and the first motor-generator 2 rotates at rotational speed N1 in positive direction under no-load condition.

When a wheel or wheels hit a step (or step-like rise) at time t1, for example, reverse travel resistance force increases, and when an instruction for increase of reverse driving force for riding over the step is output, clutch torque of the clutch mechanism 40 is gradually lowered and upshift action is started (S5). Clutch torque of the brake mechanism 30 is thereafter gradually increased from 0, and when the rotational speed sensor 35 detects predetermined rotational fluctuation (e.g., rotational speed increase of at least predetermined value) of the second ring gear 22 at time t2, i.e., when transition to inertia phase begins, driving torque of the first motor-generator 2 increases to predetermined value T1 and rotational speed of the first motor-generator 2 increases (S7).

Since upshift of the speed change mechanism 70 is thus performed when a reverse driving force increase instruction is output, the output shaft 27 can be caused to generate high torque in inertia phase while in switching transition from low-speed range to high-speed range. Moreover, the first motor-generator 2 is caused to generate driving torque that is added to the second motor-generator 3. Therefore, reverse driving force rises from F1 to F2, and the wheel(s) can easily ride over the step.

Thereafter, when, for example, rotational speed of the first motor-generator 2 reaches upper limit rotational speed Nmax at time t3, torque of the first motor-generator 2 returns to substantially 0 (S8→S10). Reverse driving force therefore falls to its original value F1. Moreover, detection of upshift completion by the rotational speed sensor 35 (e.g., when rotational speed of the second ring gear 22 becomes 0) also means that driving torque of the first motor-generator 2 is substantially 0 (S9→S10). Although not illustrated in the drawing, in such case the speed change mechanism 70 is thereafter is switched from high-speed range back to low-speed range, and operations like the aforesaid are performed at every output of an instruction for reverse driving force increase.

The present embodiment can achieve advantages and effects such as the following:

(1) The hybrid vehicle drive apparatus 100 according to the present embodiment includes: the engine 1; the first motor-generator 2; the first planetary gear mechanism 10 connected to the output shaft 1a of the engine 1 to divide and output power generated by the engine 1 to the first motor-generator 2 and the power transmission path 73 for transmitting power to axles 57; the second motor-generator 3 installed in the power transmission path 73; the second planetary gear mechanism 20 installed in the first power transmission path 71 between the second motor-generator 3 and the first planetary gear mechanism 10; the speed change mechanism 70 including the engageable/disengageable brake mechanism 30 and clutch mechanism 40 so as to change speed ratio defined as value of ratio of rotational speed of input shaft of the second planetary gear mechanism (of second carrier 24) relative to rotational speed of the output shaft 27 of the second planetary gear mechanism 20 in accordance with engagement action; and the controller 4 for controlling the engine 1, the first motor-generator 2, the second motor-generator 3 and the speed change mechanism 70 in accordance with drive mode (FIG. 1). The speed change mechanism 70 is adapted to respond to disengagement of the brake mechanism 30 and engagement of the clutch mechanism 40 by establishing first speed ratio α1 in low-speed range and to respond to engagement of the brake mechanism 30 and disengagement of the clutch mechanism 40 by establishing second speed ratio α2 (<α1) in high-speed range. Drive mode include EV reverse mode of reverse travel powered by the second motor-generator 3 with the engine 1 inactivated. The controller 4 is further adapted to determine whether a driving force increase instruction is output during traveling in EV reverse mode. The controller 4 controls the speed change mechanism 70 to disengage the brake mechanism 30 and engage the clutch mechanism 40 before a driving force increase instruction is output during traveling in EV reverse mode, and to engage the brake mechanism 30 and disengage the clutch mechanism 40 when it is determined that the driving force increase instruction is output during traveling in EV reverse mode (FIG. 5).

Thus, in EV reverse mode, switching of the speed change mechanism 70 from low-speed range to high-speed range enables generation of large torque at the output shaft 27 of the speed change mechanism 70 upon entering inertia phase while the switching is transitioning. As a result, reverse driving force can be temporarily increased so as to generate driving force of or greater than maximum torque inherent to the second motor-generator 3. This enables easy wheel ride-over of a step or similar. Moreover, as no size increase of the second motor-generator 3 is required, rise in cost and enlargement of the drive apparatus 100 can be minimized. In addition, although the brake mechanism 30 and the clutch mechanism 40 are both turned OFF during forward traveling in EV mode (FIG. 2), the speed change mechanism 70 is switched to low-speed range in advance in EV reverse mode. This ensures prompt increase of reverse driving force when a reverse driving force request is instructed.

(2) When a driving force increase instruction is determined to be output during traveling in EV reverse mode, the controller 4 controls the first motor-generator 2 so that torque output from the first motor-generator 2 is added to the second motor-generator 3. Since torque of the first motor-generator 2 is therefore applied to further increase reverse driving force, reliable ride-over or the like of step-like rises can be achieved.

(3) The hybrid vehicle drive apparatus 100 further includes the one-way clutch 1b that allows rotation of the engine 1 in one direction (positive direction) and prevents rotation of the engine 1 in reverse direction (negative direction) (FIG. 1). So when the vehicle is traveling in EV reverse mode in low-speed range before output of a driving force increase instruction, engine speed is maintained at 0 (FIG. 4A). Since this makes it possible to increase difference between rotational speed N1 of the first motor-generator 2 before output of a driving force increase instruction and upper limit rotational speed Nmax, the first motor-generator 2 can be easily controlled to generate large torque. Namely, when difference between rotational speed N1 and upper limit rotational speed Nmax is small, rotational speed of the first motor-generator 2 quickly reaches upper limit rotational speed Nmax when the first motor-generator 2 generates driving torque, thus making it hard for the first motor-generator 2 to generate large torque. In contrast, the holding of engine speed at 0 by operation of the one-way clutch 1b expands the margin for increasing rotational speed of the first motor-generator 2. This enables the first motor-generator 2 to generate large torque by means of a simple configuration.

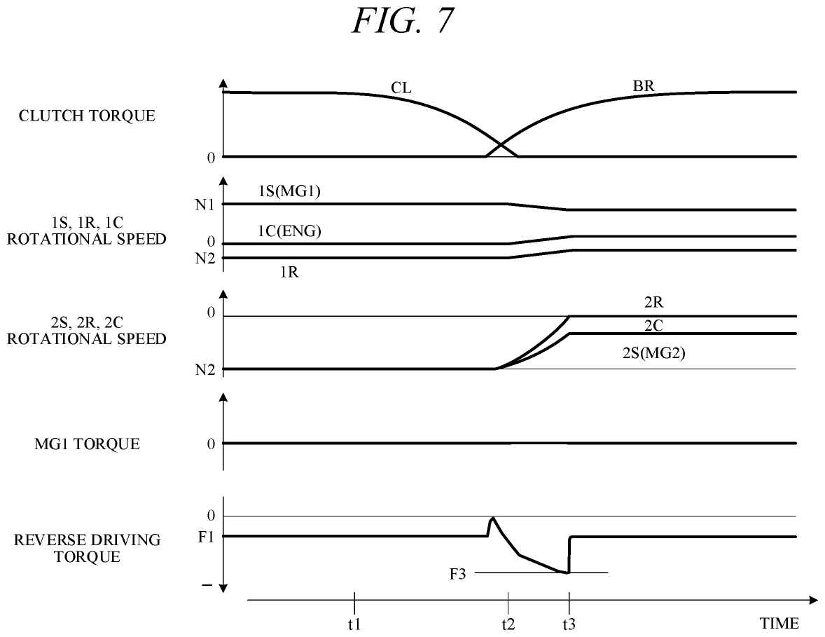

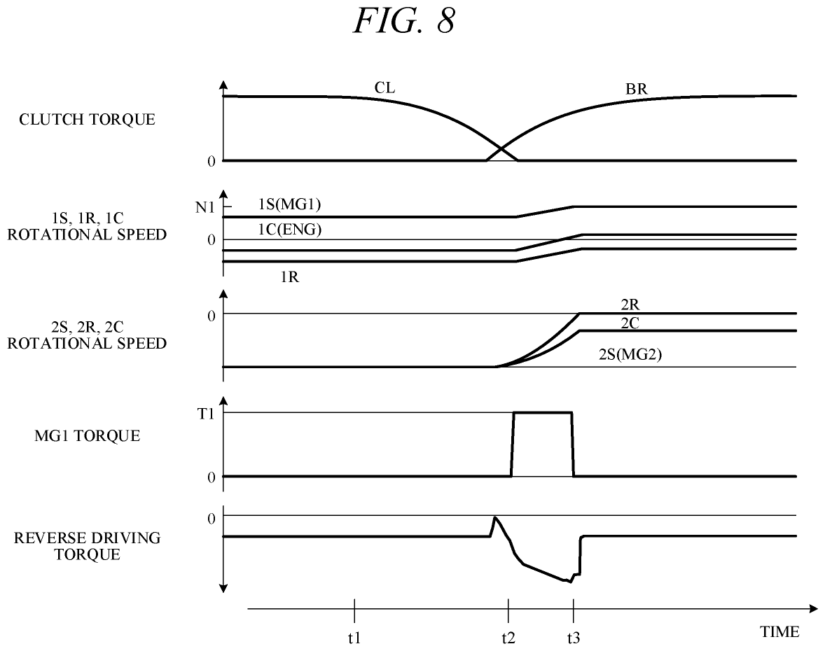

Various modifications of the aforesaid embodiment are possible. Some examples are explained in the following. In the aforesaid embodiment, the first motor-generator 2 is controlled in EV reverse mode to output driving torque in positive direction upon detection of passage into inertia phase during switching transition from low-speed range to high-speed range. However, such output of driving torque can be omitted. FIG. 7 is a time chart showing an example of operation during switching transition from low-speed range to high-speed range in a case where MG1 torque is held at substantially 0 without causing the first motor-generator 2 to generate large torque.

As shown in FIG. 7, even at MG1 torque of 0, reverse driving force increases following time t2 to reach predetermined value F3 owing to upshift of the speed change mechanism 70. In this case, however, rotational speed of the first motor-generator 2 (first sun gear 11) when inertia phase begins at time t2 is diminished and predetermined value F3 is smaller than maximum value F2 of reverse driving force in case of causing the first motor-generator 2 to generate driving torque T1 (FIG. 6). Therefore, when more reverse driving force is required, the first motor-generator 2 is preferably controlled to generate large torque during upshift.

In the aforesaid embodiment, the engine 1 is equipped with the one-way clutch 1b and minimum rotational speed of the engine 1 is mechanically limited to 0. However, the one-way clutch can be omitted. In such case, engine speed in EV reverse mode before a reverse driving force increase instruction is output can be set to a value smaller than 0. FIG. 8 is a time chart showing an example of operation in this case. As shown in FIG. 8, engine speed before a reverse driving force increase instruction is output is negative, but reverse driving force can be increased beginning from inertia phase start time t2, similarly to what is shown in FIG. 6. One aspect to be noted here is that in this case initial rotational speed of the first motor-generator 2 is lower than N1 (FIG. 6). Since the first motor-generator 2 can therefore be caused to generate driving torque larger than predetermined value T1 (in the example of FIG. 8, driving torque is T1), reverse driving force can be more greatly increased. In this case, the controller 4 can output a control signal to the first motor-generator 2 to control driving of the first motor-generator 2 so as to make engine speed in EV reverse mode before a reverse driving force increase instruction is output 0 or less.

Although in the aforesaid embodiment (FIG. 1), the speed change mechanism 70 includes the second planetary gear mechanism 20 (a planetary gear mechanism), brake mechanism 30 and clutch mechanism 40, a speed change mechanism is not limited to this configuration. The speed change mechanism need not have one each of a brake mechanism and a clutch mechanism, but can instead have a pair of brake mechanisms or a pair of clutch mechanisms. In the aforesaid embodiment (FIG. 1), the first planetary gear mechanism 10 is adapted to divide and output motive power generated by the engine 1 as an internal combustion engine to the first motor-generator 2 and the power transmission path 73. However, a power division mechanism is not limited to the aforesaid configuration.

In the aforesaid embodiment (FIG. 1), the brake mechanism 30 is configured to engage the plates 31 and disks 32 using pushing force of hydraulic pressure. However, the plates 31 and disks 32 can instead be engaged using spring biasing force and disengaged using hydraulic pressure. Similarly, as regards the clutch mechanism 40, the plates 41 and disks 42 can be engaged using spring biasing force and disengaged using hydraulic pressure. Although multi-plate wet type engagement elements are used in the brake mechanism 30 and clutch mechanism 40, band brake, dog or other type of engagement elements can be used instead. In other words, a first engagement mechanism and a second engagement mechanism are not limited to the aforesaid configurations.

In the aforesaid embodiment, the controller 4 as an electronic control unit is adapted to control actions of the brake mechanism 30 and clutch mechanism 40 so as to implement EV mode, W motor mode, series mode, HV mode (HV low mode, HV high mode), EV reverse mode and the like, but can also be adapted to implement other modes.

In the aforesaid embodiment, a start of an inertia phase during a transition state of changing speed ratio from a first speed ratio α1 to a second speed ratio α2 is detected based on signal from the rotational speed sensor 35. However, a detecting part is not limited to the aforesaid configuration. In the aforesaid embodiment, the controller 4 determines whether a driving force increase instruction is output based on signal from the vehicle speed sensor 36 as a vehicle speed detecting part for detecting a vehicle speed and the accelerator opening angle sensor 37 as a required driving force detecting part for detecting a required driving force. However, a determination unit is not limited to the aforesaid configuration.

The above embodiment can be combined as desired with one or more of the above modifications. The modifications can also be combined with one another.

According to the present invention, it is possible to increase a driving force during reverse traveling in EV mode by means of a simple configuration.

Above, while the present invention has been described with reference to the preferred embodiments thereof, it will be understood, by those skilled in the art, that various changes and modifications may be made thereto without departing from the scope of the appended claims.

What is claimed is:

1. A drive apparatus of a hybrid vehicle, comprising:
an internal combustion engine;
a first motor-generator;
a drive shaft connected to a wheel;
a power division mechanism connected to an output shaft of the internal combustion engine to divide and output a power generated by the internal combustion engine to the first motor-generator and a power transmission path configured to connect the power division mechanism and the drive shaft;
a second motor-generator disposed in the power transmission path;
a planetary gear mechanism interposed between the second motor-generator and the power division mechanism in the power transmission path;
a speed change mechanism including a first engagement mechanism configured to be engageable and disengageable and a second engagement mechanism configured to be engageable and disengageable so as to change a speed ratio defined as a value of a ratio of a rotational speed of an input shaft of the planetary gear mechanism relative to a rotational speed of an output shaft of the planetary gear mechanism, in accordance with an engagement action of the first engagement mechanism and the second engagement mechanism; and
an electronic control unit including a microprocessor configured to perform controlling the internal combustion engine, the first motor-generator, the second motor-generator and the speed change mechanism in accordance with a drive mode, wherein
the speed change mechanism is configured so that the speed ratio is a first speed ratio when the first engagement mechanism is disengaged and the second engagement mechanism is engaged and the speed ratio is a second speed ratio less than the first speed ratio when the first engagement mechanism is engaged and the second engagement mechanism is disengaged,
the drive mode includes an EV reverse mode driven by a power of the second motor-generator with the internal combustion engine inactivated to travel in reverse,
the microprocessor is configured to further perform determining whether a driving force increase instruction is output during traveling in the EV reverse mode, and
the microprocessor is configured to perform
the controlling including controlling the speed change mechanism so as to disengage the first engagement mechanism and engage the second engagement mechanism before the driving force increase instruction is output during traveling in the EV reverse mode and so as to engage the first engagement mechanism and disengage the second engagement mechanism when it is determined that the driving force increase instruction is output during traveling in the EV reverse mode.

2. The drive apparatus according to claim 1, wherein
the microprocessor is configured to perform
the controlling including controlling the first motor-generator so that a torque output from the first motor-generator is added to the second motor-generator when it is determined that the driving force increase instruction is output during traveling in the EV reverse mode.

3. The drive apparatus according to claim 2, wherein
the first engagement mechanism is a brake mechanism configured to brake a ring gear of the planetary gear mechanism during engaging and non-brake the ring gear during disengaging, and
the second engagement mechanism is a clutch mechanism configured to join a sun gear of the planetary gear mechanism and the ring gear during engaging and separate the sun gear and the ring gear during disengaging.

4. The drive apparatus according to claim 2, further comprising
a detecting part configured to detect a start of an inertia phase during a transition state when the speed ratio is changed from the first speed ratio to the second speed ratio, wherein
the microprocessor is configured to perform
the controlling including controlling the first motor-generator so that the torque output from the first motor-generator is added to the second motor-generator when the start of the inertia phase is detected by the detecting part after it is determined that the driving force increase instruction is output during traveling in the EV reverse mode.

5. The drive apparatus according to claim 1, further comprising
a one-way clutch configured to allow a rotation of the internal combustion engine in a first direction and prevent the rotation of the internal combustion engine in a second direction opposite to the first direction.

6. The drive apparatus according to claim 1, wherein
the microprocessor is configured to perform
the controlling including controlling the first motor-generator so that a rotational speed of the internal combustion engine is less than or equal to 0 before the driving force increase instruction is output during traveling in the EV reverse mode.

7. The drive apparatus according to claim 1, further comprising:
a vehicle speed detecting part configured to detect a vehicle speed of the hybrid vehicle; and
a required driving force detecting part configured to detect a required driving force of the hybrid vehicle, wherein
the microprocessor is configured to perform
the determining including determining whether the driving force increase instruction is output during traveling in the EV reverse mode based on the vehicle speed detected by the vehicle speed detecting part and the required driving force detected by the required driving force detecting part.

8. A drive method of a hybrid vehicle, the hybrid vehicle including an internal combustion engine; a first motor-generator; a drive shaft connected to a wheel; a power division mechanism connected to an output shaft of the internal combustion engine to divide and output a power generated by the internal combustion engine to the first motor-generator and a power transmission path configured to connect the power division mechanism and the drive shaft; a second motor-generator disposed in the power transmission path; a planetary gear mechanism interposed between the second motor-generator and the power division mechanism in the power transmission path; and a speed change mechanism including a first engagement mechanism configured to be engageable and disengageable and a second engagement mechanism configured to be engageable and disengageable so as to change a speed ratio defined as a value of a ratio of a rotational speed of an input shaft of the planetary gear mechanism relative to a rotational speed of an output shaft of the planetary gear mechanism, in accordance with an engagement action of the first engagement mechanism and the second engagement mechanism, the speed change mechanism being configured so that the speed ratio is a first speed ratio when the first engagement mechanism is disengaged and the second engagement mechanism is engaged and the speed ratio is a second speed ratio less than the first speed ratio when the first engagement mechanism is engaged and the second engagement mechanism is disengaged,
the drive method comprising:
controlling the internal combustion engine, the first motor-generator, the second motor-generator and the speed change mechanism in accordance with a drive mode; and
determining whether a driving force increase instruction is output during traveling in an EV reverse mode driven by a power of the second motor-generator with the internal combustion engine inactivated to travel in reverse, wherein
the controlling includes controlling the speed change mechanism so as to disengage the first engagement mechanism and engage the second engagement mechanism before the driving force increase instruction is output during traveling in the EV reverse mode and so as to engage the first engagement mechanism and disengage the second engagement mechanism when it is determined that the driving force increase instruction is output during traveling in the EV reverse mode.
